(19) United States
(12) Patent Application Publication
(10) Pub. No.: US 2025/0375814 A1
(43) Pub. Date: Dec. 11, 2025

(54) SYSTEMS AND METHODS FOR COMPOSITIONALLY AND STRUCTURALLY-GRADED COMPOSITES VIA LIQUID METAL BINDER JETTING

(71) Applicant: Lawrence Livermore National Security, LLC, Livermore, CA (US)

(72) Inventor: Kellen David TRAXEL, Newcastle, WA (US)

(21) Appl. No.: 18/738,616

(22) Filed: Jun. 10, 2024

(51) Int. Cl. B22F 10/14; B22F 10/30; B22F 12/53; B22F 12/60; B22F 12/90; B28B 1/00; B33Y 10/00; B33Y 30/00; B33Y 50/02

(52) U.S. Cl. CPC B22F 10/14; B22F 10/30; B22F 12/53; B22F 12/60; B22F 12/90; B28B 1/001; B33Y 10/00; B33Y 30/00; B33Y 50/02; B22F 2998/10

(57) ABSTRACT

Systems and methods are disclosed for creating a ceramic-metal composite part through a layer-by-layer additive manufacturing process. In one implementation the method involves depositing a layer of powder particles on a build table, and then depositing molten metal binding droplets onto the powder particles at one or more select locations of the powder particles to bind one or more select portions of the powder particles together and to fill interstitial spaces between adjacent ones of the powder particles, to thus form a first two-dimensional layer of the part. These operations are repeated to form additional layers of the part until the part is complete.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to systems and methods for fabricating complex shaped ceramic-metal composites, and more particularly to systems and methods for fabricating complex shaped ceramic composite structures with spatially varying geometry, material composition and properties through successive jetting of molten binding droplets onto each layer of ceramic powder during the printing process.

### BACKGROUND

The statements in this section merely provide background information related to the present disclosure and may not constitute prior art.

Binder jetting is an established additive manufacturing technique that utilizes controlled ejection of polymeric binder onto a baseplate of ceramic or metal powder. This process creates geometrically complex green compacts that require subsequent post-processing. This process is most known for its ability to fabricate complex metallic components without the need for high energy input sources used in powder-bed-fusion (PBF) or directed energy deposition, as well as the ability to cheaply fabricate intricate ceramic green bodies for sand cast molds or tooling applications.

A typical binder jetting system is shown in FIG. 1. Such a system typically includes a printhead that contains the various nozzles, a polymeric binder system, as well as a build platform (“build envelop”) and re-coater system (“powder supply”). The printhead “P” that ejects the polymeric binder is like a (2D) inkjet printhead that utilizes a specifically designed array of nozzles that can jet droplets into complex arrays that end up binding the ceramic or metal powder together. To print a layer, the build platform “BP” is lowered and a re-coater “R” moves a layer of powder across the build platform. The inkjet printhead P then moves over the top surface of the powder layer while jetting out polymeric binder in a controlled manner to bind powder together in areas that will become solid after post-sintering. After the printhead P moves across the surface, the recoating process is repeated such that a sequence of layers can build from one another to make a full-3D green body. After fabrication of the green body, the part is pulled from the powder bed, de-powdered, and prepared for de-binding and post-sintering operations to densify the part and increase its structural integrity.

As-printed parts made using the above-described traditionally binder jetting process are quite fragile in the green state, and due to the post-sintering treatment, parts that are produced using this method are subject to significant shrinkage during post-sintering. This can result in cracking and scrapped parts, depending on the care that is placed on the heating/cooling rates, as well as the environmental conditions involved in the post-sintering process. In the case of ceramic part fabrication, where ceramic powder is used instead of metal powder, a post-processing infiltration of metal is sometimes utilized to bring the density of the printed material near to 100%, resulting in a ceramic-metal composite that can be utilized in tooling applications such as machining/cutting or as sand cast molds.

Accordingly, there remains a need in the art for a binder jetting additive manufacturing process that does not suffer from the above limitations and drawbacks.

### SUMMARY

This section provides a general summary of the disclosure, and is not a comprehensive disclosure of its full scope or all of its features.

In one aspect the present disclosure relates to an additive manufacturing method for creating a metal composite part through a layer-by-layer additive manufacturing process. The method may comprise depositing a layer of powder particles on a build table. The method may further involve depositing molten binding droplets onto the powder particles at one or more select locations of the powder particles to bind one or more select portions of the powder particles together and to fill interstitial spaces between adjacent ones of the powder particles, to thus form a first two-dimensional layer of the part. The method may further involve depositing an additional layer of powder particles onto the first two-dimensional layer of the part. The method may further involve depositing an additional layer of molten binding droplets onto one or more select locations of the additional layer of powder particles to bind one or more select portions of the additional layer of powder particles together and to fill interstitial spaces between adjacent ones of the powder particles of the additional layer, to thus form a second two dimensional layer of the part.

In another aspect the present disclosure relates to a method for creating a metal composite part through a layer-by-layer additive manufacturing process. The method may comprise using a re-coater subsystem to deposit a layer of powder particles on a build table. The method may further comprise using a heater to heat a quantity of metal to a molten state to create molten metal. The method may further comprise using a nozzle to receive the molten metal, and using a motion control subsystem to controllably move the nozzle within an X/Y plane while the nozzle ejects the molten metal as molten metal binding droplets onto the powder particles at one or more select locations of the layer of powder particles. This binds one or more select portions of the powder particles together and fills interstitial spaces between adjacent ones of the powder particles, to thus form a first two-dimensional layer of the part. The method may further include using the re-coater subsystem to deposit an additional layer of powder particles onto the first two-dimensional layer of the part, and then using the motion control subsystem to further control movement of the nozzle to eject an additional layer of molten metal binding droplets onto one or more select locations of the additional layer of powder particles. This binds one or more select portions of the additional layer of powder particles together and fills interstitial spaces between adjacent ones of the powder particles of the additional layer, to thus form a second two dimensional layer of the part.

In still another aspect the present disclosure relates to an additive manufacturing system for creating a metal composite part through a layer-by-layer additive manufacturing process. The system may comprise a reservoir for containing a quantity of powder particles, and a re-coater subsystem for receiving the powder particles from the reservoir and depositing a layer of the powder particles having a desired thickness onto a build table. The system may further include a re-coater movement subsystem for controlling motion of the re-coater subsystem in an X/Y plane. A reservoir may also be included for holding a quantity of binding feedstock. A heater may be included for heating the binding feedstock into a molten state to create a molten binding feedstock. A nozzle may be included for receiving the molten binding feedstock and ejecting molten binding droplets therefrom onto the layer of powder particles at one or more select locations of the powder particles to bind one or more select portions of the powder particles together and to fill interstitial spaces between adjacent ones of the powder particles, to thus form a first two-dimensional layer of the part. An electronic control system may also be included for controlling operation of the nozzle as needed to form additional layers of the two-dimensional part to complete manufacture of the two-dimensional part.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is a perspective view of a typical prior art binder jetting system;

FIGS. 2a-2d show operations that may be carried out in spreading a ceramic powder layer onto a build table, using a nozzle to deposit molten metal droplets at precise areas onto and around the ceramic powder particles to bind the ceramic powder particles together and to fill interstitial spaces between the ceramic powder particles, and repeating the process to form a subsequent layer of a part;

FIG. 3a is a side elevation view of a nozzle that has a varying thermal load requirement and is constructed in accordance with the teachings of the present disclosure, wherein the nozzle has a graded-ceramic construction to place a greater percentage of ceramic material at a tip of the nozzle where heat will be the greatest;

FIG. 3b is a cross-sectional view of the nozzle of FIG. 3a taken in accordance with section line 3b-3b in FIG. 3a illustrating the graded nature of the ceramic material throughout a vertical dimension of the nozzle;

FIG. 3c is a plan view of a wall portion of the nozzle in accordance with the dashed lines in FIG. 3b further illustrating the graded concentration of ceramic particles throughout the height of the nozzle wall; and

FIG. 4 is a high level drawing of one example of a system in accordance with the present disclosure for creating ceramic-metal parts.

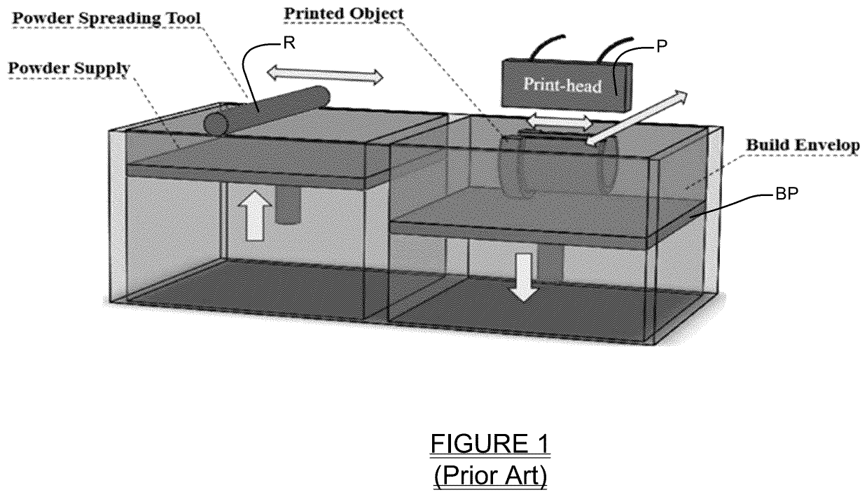

### DETAILED DESCRIPTION

Example embodiments will now be described more fully with reference to the accompanying drawings.

Binder jetting is a well-known process for additive-based fabrication of single-material metallic or ceramic green bodies, but up until the filing of the present disclosure, it has not been leveraged for manufacturing multi-material structures composed of both a ceramic and metallic phase in the same processing step. The systems and methods of the present disclosure accomplish this by substituting the polymer-based inkjet printhead for a liquid metal-based printhead capable of controlled ejection of molten metal droplets, and operating the printer in the same overall procedure as the well-known binder jetting approach. An important difference between liquid metal binder jetting and standard polymeric-based binder jetting is that there is no de-binding or post-sintering required for parts fabricated through this method since the metal “binder” is solidifying around the ceramic particles. Of course, in some applications, microstructural modification of the metallic phase may require separate heat treatment to achieve the proper combination of properties.

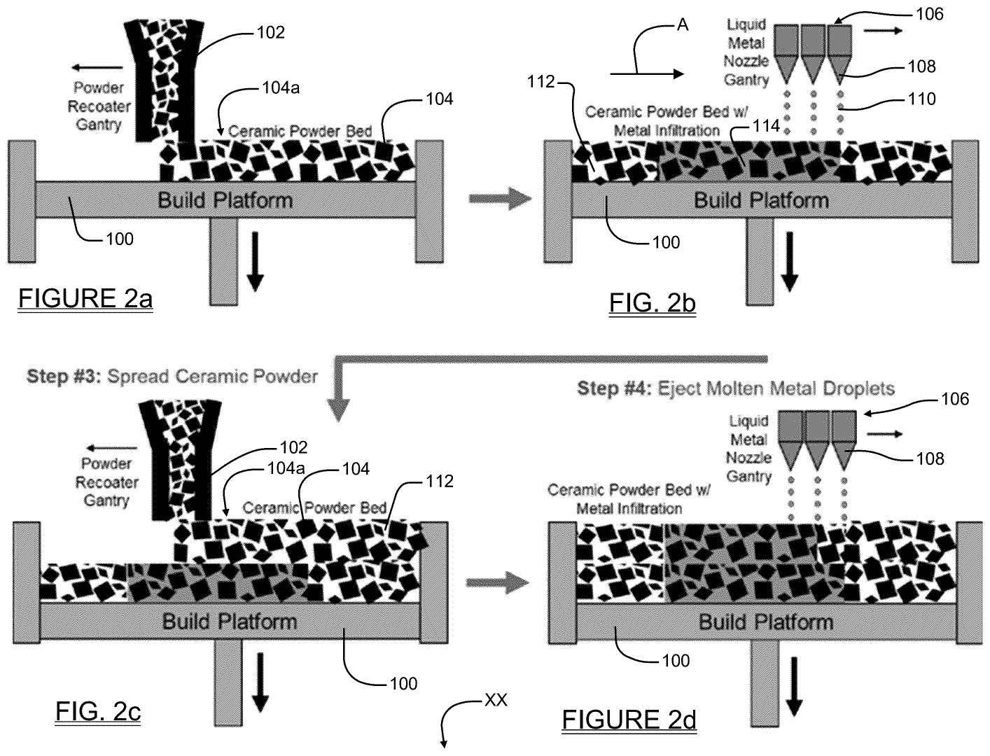

One example of a new liquid metal binder jetting process in accordance with the present disclosure is shown in FIGS. 2a-2d. Referring to FIG. 2a, a main build platform 100 is lowered and a ceramic powder re-coater 102 doses out a layer of ceramic powder particles 104 to form a ceramic powder layer 104a. Next, in FIG. 2b a movable liquid metal nozzle gantry 106 carrying one or more nozzles 108, and disposed closely adjacent (typically within 1 mm-5 mm) of one another, and where the tips of the nozzles are spaced typically about 1 mm-10 mm above an upper surface of the ceramic powder layer 104a, is controlled to begin depositing molten metal 110 from one or more of the nozzles 108. The nozzle gantry 106 is then moved laterally directly above the build platform 100 in accordance with arrow A and a sequence of ejections of the molten metal droplets 110 are initiated to realize the bulk-sections of a part which is to be formed. The ejections of the molten metal droplets 110 are carefully controlled and carefully located so that the molten metal droplets 110 land on the ceramic powder layer 104a in regions where there will be bulk-sections, and not overflow into regions where there is not meant to be a solid section of the part. More specifically, upon impinging the ceramic powder layer 104a layer, the molten metal droplets 110 coalesce into a plurality of larger molten metal melt droplets, wet the ceramic powder particles 104, and flow into crevices and interstitial spaces 112 (hereinafter simply “crevices” 112) between the ceramic powder particles, as denoted by reference number 114. As the molten metal droplets 110 flow into the crevices 112, they then begin to cool and solidify into the desired print-layer geometry for a specific 2D cross-sectional layer of the part being formed. The operations described above relating to FIGS. 2a and 2b are repeated as shown in FIGS. 2c and 2d, and the part is thus built up layer-by-layer until the part being formed in fully completely formed.

By controlling the location and size of the ejected molten metal droplets 110, as well as the layer thickness and powder size distribution of the ceramic powder layer 104a, complex shapes and variable compositions of metal-ceramic structures can be fabricated.

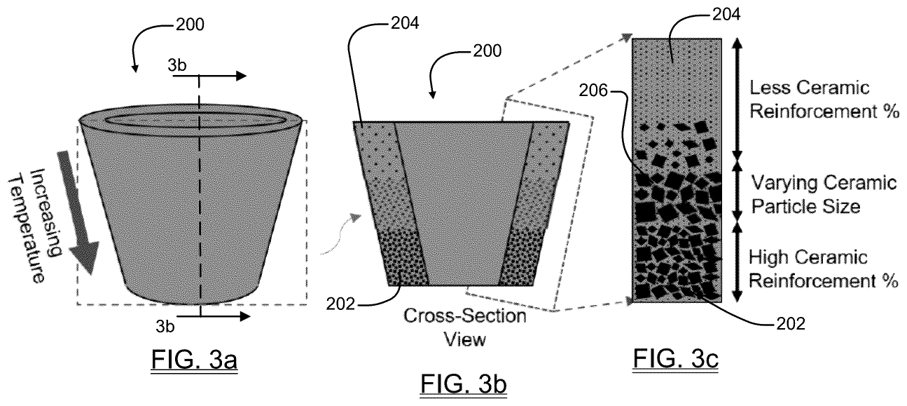

One specific example of a highly useful application for liquid metal binder jetting is shown in FIGS. 3a-3c, which involves the manufacture of a high-temperature leading edge structure for a nozzle 200 with variable ceramic reinforcement percentage and particle size. The nozzle 200 forms a graded-density, high-temperature nozzle which may be created in a singular processing operation by the systems and methods described herein. By adjusting the ratio of ceramic powder layer height and size of molten metal droplets, variable amounts of metal-ceramic phase constitution can be realized. At a base 202 of the nozzle 200, as shown in FIGS. 3b and 3c, where the temperature is highest during use of the nozzle during a printing operation, the nozzle is constructed with a higher ratio of ceramic to metal. However, at a tip 204 of the nozzle 200 where the temperature during use of the nozzle will be lower, the design is entirely metallic. A mid-range portion 206 there may be more of a 50/50 mixture of ceramic and metal particles. Thus, the variation in ceramic particle reinforcement percentage and particle size can be tuned to tailor the physical properties of parts that will be experiencing location-specific temperatures during actual use of the part.

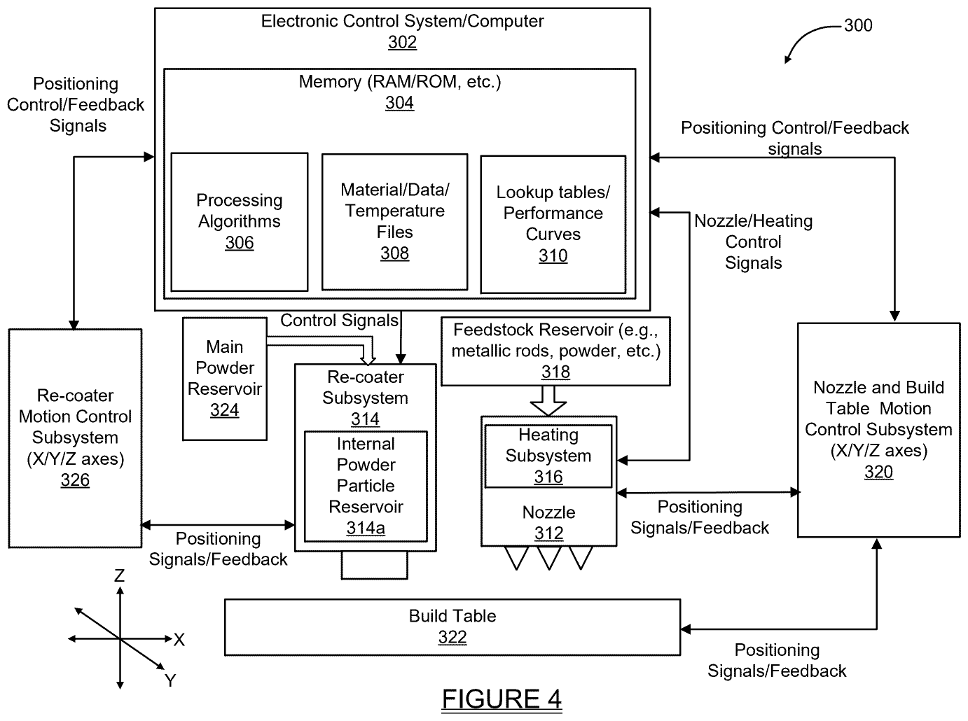

Referring briefly to FIG. 4, one high level example of a system 300 for carrying out the various methods described herein is shown. In this example the system 300 includes an electronic control system (e.g., computer) 302 having a memory 304, which may be RAM/ROM/DRAM or any other form of non-volatile and volatile memory. The memory 304 may contain modules containing processing algorithms 306, material/data/temperature files 308 and/or look-up tables and performance curves 310. Essentially, whatever information is needed for the ceramic and metal feedstock materials to be processed during a printing operation (e.g., required heating temps and/or heating times based on metallic materials, etc.) may be included in the modules 306-310.

Referring further to FIG. 4, the system 300 includes a nozzle 312 and a re-coater subsystem 314. The re-coater subsystem 314 may be similar or identical to re-coater 102 shown in FIG. 2. The nozzle 312 may include a heating subsystem 316 or the heating subsystem may be external to the nozzle. In either event, the heating subsystem 316 heats metallic feedstock supplied from a reservoir 318, to a sufficiently high temperature to place it in a molten state such that the nozzle 312 is able to eject molten metal droplets. The feedstock may be metal rods, wire, shot, fibers, or powder particles, or possibly even other forms of metallic feedstock, and the present disclosure is not limited to any one specific form of metallic feedstock. The droplets ejected from the nozzle 312 may vary in size according to various considerations including, but not limited to, desired layer thickness, metallic phase percentage or layer-specific geometric feature construction. However, in many applications it is expected that droplets on the order of 50 μm-1 mm in diameter will be appropriate. A nozzle and build table motion control subsystem 320 having suitable motion control elements (e.g., DC stepper motors, linear actuators, etc.) may be included to control X, Y and/or Z axis positioning of the nozzle 312 and/or of a build table 322 on which the part is being constructed in a layer-by-layer fashion.

With still further reference to FIG. 4, the system 300 may also include a main, external ceramic powder particle reservoir 324 for carrying a relatively large quantity of powder particles (e.g., ceramic powder particles, or even ceramic fibers). The main powder particle reservoir 324 is in communication with the re-coater subsystem 314 and feeds powder particles into the re-coater subsystem. The re-coater subsystem 314 typically also carries a much smaller reservoir 314a from which it dispenses powder particles onto the build table 322. The main external powder reservoir 324 periodically replenishes the internal powder particle reservoir 314a during operation of the system 300, and may use signals from commonly available level sensors disposed in the internal powder particle reservoir 314a to indicate when replenishment is needed. The level sensor signals may be communicated directly to an internal controller within, or associated with, the main powder reservoir 324, or to the electronic control system 302, which then signals the main powder reservoir to release a needed quantity of powder particles to the re-coater subsystem 314. The re-coater subsystem 314 may be controlled by a re-coater motion control subsystem 326 comprised of suitable positioning components (e.g., DC stepper motors, linear actuators, etc.) for positioning the re-coater subsystem 314 in X, Y and Z axes in a highly accurate manner.

The systems and methods of the present disclosure further enable the specific metal used in printing of the first few layers of the part to be easily changed to a different alloy or base metal on subsequent layers. This further enables tailoring the properties and characteristics of these composites. Again, by controlling the location and size of the ejected metal droplets, as well as the layer thickness and powder size distribution of the ceramic powder layer, complex shapes and variable composition and reinforcement percentages of metal-ceramic structures can be fabricated.

The liquid metal binder jetting systems and methods described herein are not limited to producing exclusively ceramic-metal composites from a strict molten metal-ceramic powder bed setups. For example, the powder (instead of ceramic) could be metallic in nature, and the molten droplets could instead be molten salts. This could result in unique combinations of metal-metal, metal-salt, or salt-ceramic composites, as well as material couples that interact during printing to form in situ phases in the as-printed condition. As a result, the teachings presented herein can create finished 3D parts with variable, customized material composition and geometry depending on the design of the printed component, in addition to the (firstly proposed) ceramic-metal composites. The present disclosure provides the capability to produce composites with truly interesting characteristics in the as-printed condition, provided that the wettability is sufficient between the different phases.

The methods of the present disclosure described herein are fast relative to other metal-ceramic fabrication methods that utilize multi-step de-binding and sintering sequences to achieve final density of green-body parts. The methods described herein are also much more geometrically flexible owing to the “additive” nature of the process, which does not require casting molds or other complex tooling setups. Compared to other additive manufacturing methods for metals such as powder bed fusion and directed energy deposition, the energy requirement is minimal owing to the absence of a concentrated energy source to fuse metallic particles together. The systems and methods make use of heating sources to keep the molten metal in the liquid state for jetting, but this is similar to the requirements for casting apparatuses that are well established in industrial settings. Further, waste radiative heat from the heating elements around the nozzles (or from the nozzles themselves) could be directed at the powder bed to help pre-heat the powder and stimulate enhanced wettability between the metal and ceramic materials. These attributes make the methods of the present disclosure especially attractive to use for either low-volume and limited scale components used in high-value engineering systems, or medium-to-high volume production of standard components.

The systems and methods of the present disclosure are expected to find significant utility in applications requiring parts that are designed to exhibit a combination of thermal, mechanical and/or wear resistant properties in different locations along the component. Examples include reentry vehicles that require high thermal and mechanical resistant properties depending on their proximity to the leading edge and highest exhibited temperatures (defense and aerospace), nuclear shielding applications where variable densities within single components are of interest (fission and fusion power plants), graded density impactors or armor applications where varying deformation properties within components are of interest (defense), application-specific cutting tools or fabrication tooling where different wear resistant and thermal resistant properties are desirable in specific components (general manufacturing).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. As used herein, the term “about”, when used immediately previous to a specific recited value, denotes the specific recited value as well as all values, inclusive, from +/−10% of the specific recited value.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An additive manufacturing method for creating a metal composite part through a layer-by-layer additive manufacturing process, the method comprising:
depositing a layer of powder particles on a build table;
depositing molten binding droplets onto the powder particles at one or more select locations of the powder particles to bind one or more select portions of the powder particles together and to fill interstitial spaces between adjacent ones of the powder particles, to thus form a first two-dimensional layer of the part;
depositing an additional layer of powder particles onto the first two-dimensional layer of the part; and
depositing an additional layer of molten binding droplets onto one or more select locations of the additional layer of powder particles to bind one or more select portions of the additional layer of powder particles together and to fill interstitial spaces between adjacent ones of the powder particles of the additional layer, to thus form a second two dimensional layer of the part.

2. The method of claim 1, wherein depositing a layer of powder particles comprises depositing a layer of ceramic powder particles.

3. The method of claim 1, wherein depositing an additional layer of powder particles comprises depositing an additional layer of ceramic powder particles.

4. The method of claim 1, wherein depositing a layer of powder particles comprises depositing a layer of metal powder particles.

5. The method of claim 1, wherein depositing an additional layer of powder particles comprises depositing an additional layer of metal powder particles.

6. The method of claim 1, wherein depositing molten binding droplets comprises depositing molten salt binding particles.

7. The method of claim 1, wherein depositing a layer of powder particles comprises using a re-coater subsystem to deposit and spread evenly the layer of powder particles onto the build table.

8. The method of claim 1, wherein the depositing molten binding droplets onto the powder particles at one or more select locations of the powder particles to bind one or more select portions of the powder particles together and to fill interstitial spaces between adjacent ones of the powder particles comprises using a heater to heat a metal feedstock into a molten state to create molten metal binding droplets, and using a nozzle to eject the molten metal binding droplets onto the layer of powder particles.

9. The method of claim 8, further comprising using at least one of an electronic control system or a computer to control positioning of the nozzle while the molten metal binding droplets are being ejected from the nozzle.

10. The method of claim 7, further comprising using at least one of an electronic control system or a computer to control movement of the re-coater subsystem.

11. A method for creating a metal composite part through a layer-by-layer additive manufacturing process, the method comprising:
using a re-coater subsystem to deposit a layer of powder particles on a build table;
using a heater to heat a quantity of metal to a molten state to create molten metal;
using a nozzle to receive the molten metal;
using a motion control subsystem to controllably move the nozzle within an X/Y plane while the nozzle ejects the molten metal as molten metal binding droplets onto the powder particles at one or more select locations of the layer of powder particles to bind one or more select portions of the powder particles together and to fill interstitial spaces between adjacent ones of the powder particles, to thus form a first two-dimensional layer of the part;
using the re-coater subsystem to deposit an additional layer of powder particles onto the first two-dimensional layer of the part; and
using the motion control subsystem to further control movement of the nozzle to eject an additional layer of molten metal binding droplets onto one or more select locations of the additional layer of powder particles to bind one or more select portions of the additional layer of powder particles together and to fill interstitial spaces between adjacent ones of the powder particles of the additional layer, to thus form a second two dimensional layer of the part.

12. The method of claim 11, wherein using the re-coater subsystem comprises using an additional motion control subsystem to control movement of the re-coater subsystem in an X/Y plane above the build table.

13. The method of claim 11, wherein depositing a layer of powder particles comprises at least one of:
depositing a layer of ceramic powder particles; or
depositing a layer of metal powder particles; or
depositing a layer of ceramic fibers; or
depositing a layer of metal fibers.

14. The method of claim 11, wherein depositing molten metal binding droplets comprises depositing molten metal binding droplets between 50 μm and 1 mm in diameter.

15. The method of claim 11, wherein depositing a layer of powder particles comprises depositing a layer of powder particles having a diameter of between 5 μm and 250 μm.

16. An additive manufacturing system for creating a metal composite part through a layer-by-layer additive manufacturing process, the system comprising:
a reservoir for containing a quantity of powder particles;
a re-coater subsystem for receiving the powder particles from the reservoir and depositing a layer of the powder particles having a desired thickness onto a build table;
a re-coater movement subsystem for controlling motion of the re-coater subsystem in an X/Y plane;
a reservoir for holding a quantity of binding feedstock;
a heater for heating the binding feedstock into a molten state to create a molten binding feedstock;
a nozzle for receiving the molten binding feedstock and ejecting molten binding droplets therefrom onto the layer of powder particles at one or more select locations of the powder particles to bind one or more select portions of the powder particles together and to fill interstitial spaces between adjacent ones of the powder particles, to thus form a first two-dimensional layer of the part; and
an electronic control system for controlling operation of the nozzle as needed to form additional layers of the two-dimensional part to complete manufacture of the two-dimensional part.

17. The system of claim 16, wherein the re-coater is configured to contain and deposit a quantity of ceramic powder particles.

18. The system of claim 16, wherein the heater is configured to heat at least one of a metal rod or metal powder particles to create the molten binding feedstock.

19. The system of claim 16, wherein the electronic control system is configured to control operation of the re-coater subsystem.

20. The system of claim 16, wherein the nozzle includes the heater.
